(19) United States
(12) Patent Application Publication
(10) Pub. No.: US 2018/0335817 A1
(43) Pub. Date: Nov. 22, 2018

(54) DATA STORAGE SYSTEM AND EXTERNAL POWER SUPPLY MODULE CAPABLE OF PROVIDING A STANDBY POWER

(71) Applicant: Innodisk Corporation, New Taipei City (TW)

(72) Inventors: Yen-Chih LIN, New Taipei City (TW); Ying-Kun WU, New Taipei City (TW)

(21) Appl. No.: 15/656,190

(22) Filed: Jul. 21, 2017

(30) Foreign Application Priority Data
May 16, 2017 (TW) 106116194

(51) Int. Cl. G06F 1/26; G06F 1/32

(52) U.S. Cl. CPC G06F 1/266; G06F 1/3287; G06F 1/3296

(57) ABSTRACT

The invention provides an external power supply module. The external power supply module comprises at least one capacitor module. A power supply unit provides a power energy to the capacitor module. The external power supply module outputs an output energy to a data storage device. When the power supply unit provides the power energy, the external power supply module will generate the output energy based on the power energy. When the power supply unit interrupts to provide the power energy, the external power supply module will generate the output energy based on a standby power provided by the capacitor module. Thus, a user can reconfigure a new external power supply module between the power supply unit and the data storage device when the capacitor module of the original external power supply module has aged, so as to finish the aged replacement of the capacitor module.

This non-provisional application claims priority claim under 35 U.S.C. § 119(a) on Taiwan Patent Application No. 106116194 filed May 16, 2017, the entire contents of which are incorporated herein by reference.

### FIELD OF THE INVENTION

The present invention relates to a data storage system and external power supply module, particularly to a data storage system and external power supply module capable of providing a standby power used in data storage.

### BACKGROUND

In order to avoid the power outage occurred during the data storage system performing the writing of important data, a data storage device of the data storage system can additional configure a capacitor module capable of providing a power energy. When the power outage occurs, the required work power that the data storage device performs the writing of data can be provided by the discharging of the capacitor module. However, the capacitor module will gradually generate physical aging with the use of time, such that the charge storage capacity of the capacitor module is getting worse. Therefore, the aged capacitor module must be replaced in advance, so as to avoid the data storage system in writing the important data to be affected.

FIG. 1 is a structure schematic diagram of a data storage device in prior art. As shown in FIG. 1, a data storage device 100 in prior art comprises a housing 10. A circuit board 11 is able to be provided inside the housing 10. A data transmission interface 12, a controller 13, a plurality of data storage elements 15, and a capacitor module 17 are disposed on the circuit board 11. When the capacitor module 17 is to be replaced, a repairer must open the housing 10 to take out the circuit board 11 from the housing 10. After the circuit board 11 is taken out from the housing 10, the repairer can dismount the capacitor module 17 from the circuit board 11 by using a dismounting tool (e.g., a welding torch), and weld a new capacitor module 17 on the circuit board 11. Thus, the replacement of the capacitor module 17 can be finished.

The replacement process of the capacitor module 17 inside the data storage device 100 in prior art is very cumbersome. Moreover, the capacitor module 17 is usually incapable of being replaced by a user himself, and must be returned to the factory to be replaced with a new one, due to the fact that the capacitor module 17 is welded on the circuit board 11, causing in the trouble in the replacement of the capacitor module 17.

### SUMMARY

It is one object of the present invention to provide a data storage system, which comprises a power supply unit, a data storage device, and an external power supply module. The external power supply module is configured between the power supply unit and data storage device, and comprises at least one capacitor module. The capacitor module can provide a standby power to the data storage device in a power outage of the power supply unit. When the capacitor module of the external power supply module has aged or damaged, the user can reconfigure a new external power supply module between the power supply unit and the data storage device so as to finish the replacement process of the capacitor module. Accordingly, the capacitor module is configured in the outside of the data storage device, which can increase the convenience in the replacement of the capacitor module.

It is one object of the present invention to provide a data storage system, in which the user may replace an external power supply module having an appropriate capacity in the data storage system according to the requirement of data access in the actual.

To achieve the above object, the present invention provides an external power supply module capable of providing a standby power, comprising: at least one capacitor module; a power input end connected to the capacitor module and a power supply unit, wherein the power supply unit provides a power energy to the capacitor module via the power input end, the capacitor module can be charged by the power energy; and a power output end connected to the capacitor module and a data storage device; wherein the external power supply module outputs the power energy to the data storage device when the power supply unit provides the power energy; the external power supply module outputs the standby power provided by the capacitor module to the data storage device when the power supply unit interrupts to provide the power energy.

In one embodiment of the present invention, the external power supply module further comprises a voltage detector that is connected to the power input end and used to detect a voltage value of the power energy, wherein the external power supply module outputs the power energy to the data storage device when the voltage value of power energy is higher than a threshold value, or the external power supply module outputs the standby power to the data storage device when the voltage value of power energy is lower than the threshold value.

In one embodiment of the present invention, the external power supply module further comprises a power switch unit connected to the voltage detector, the power switch unit is connected to the power input end by the controlling of the voltage detector when the voltage value of power energy is higher than the threshold value, or the power switch unit is connected to the capacitor module by the controlling of the voltage detector when the voltage value of power energy is lower than the threshold value.

In one embodiment of the present invention, the external power supply module further comprises a first connection line and a second connection line, the power input end is connected to the power supply unit via the first connection line, and the power output end is connected to the data storage device via the second connection line.

In one embodiment of the present invention, wherein the power supply unit comprises a first connection interface, the data storage device comprises a second connection interface, the first connection line is connected to the first connection interface of the power supply unit, the second connection line is connected to the second connection interface of the data storage device.

In one embodiment of the present invention, wherein a housing of the external power supply module is disposed on a board body, the external power supply module is able to be fixed on an object by the board body.

In one embodiment of the present invention, wherein the board body and the object comprise at least one hole, respectively, a fixed element is through the holes of the board body and the object so as to fix the board body on the object.

The present invention further provides a data storage system capable of providing a standby power, comprising: a data storage device; and an external power supply module comprising at least one capacitor module, a power input end, and a power output end, the power input end connected to the capacitor module and a power supply unit, the power output end connected to the capacitor module and the data storage device, wherein the power supply unit provides a power energy to the capacitor module via the power input end, the capacitor module can be charged by the power energy; wherein the external power supply module outputs the power energy to the data storage device when the power supply unit provides the power energy; the external power supply module outputs the standby power provided by the capacitor module to the data storage device when the power supply unit interrupts to provide the power energy.

### BRIEF DESCRIPTION OF THE DRAWINGS

FIG. 1 is a structure schematic diagram of a data storage device in prior art.

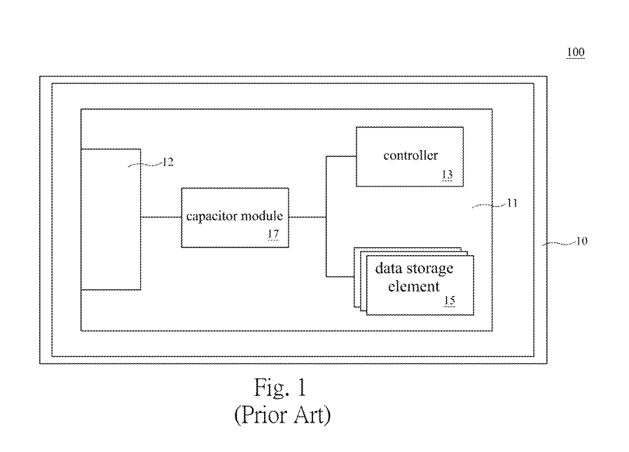

FIG. 2 is a block diagram of a data storage system of the present invention.

FIG. 3 is a structural stereogram diagram of the external power supply module according to one embodiment of the present invention.

FIG. 4 is a structural cross-sectional diagram of the external power supply module according to one embodiment of the present invention.

FIG. 5 is a circuit diagram of the external power supply module according to one embodiment of the present invention.

### DETAILED DESCRIPTION OF THE PREFERRED EMBODIMENTS

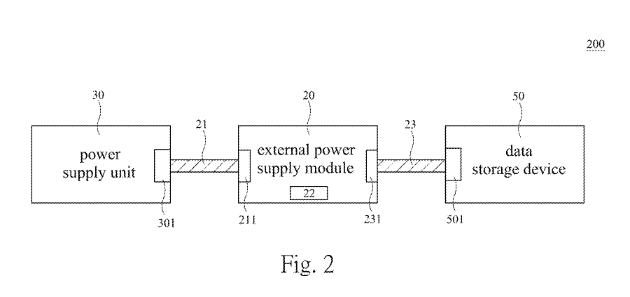

Referring to FIG. 2, there is shown a block diagram of a data storage system of the present invention. As shown in FIG. 2, the data storage system 200 comprises an external power supply module 20, a power supply unit 30, and a data storage device 50. The external power supply module 20 is connected between the power supply unit 30 and the data storage device 50. In an embodiment of the present invention, the power supply unit 30 is a computer host, a power supply, or a power socket, and the data storage device 50 is a flash memory device (SSD) or a traditional hard disk device (HDD).

The external power supply module 20 comprises at least one capacitor module 22, a power input end 211, and a power output end 231. The capacitor module 22 is used for storing electrical energy. The power input end 211 and the power output end 231 are electrically connected to the capacitor module 22, respectively. The power supply unit 30 comprises a first connection interface 301, and the data storage device 50 comprises a second connection interface 501.

The power input end 211 of the external power supply module 20 is connected to the first connection interface 301 of the power supply unit 30 via a first connection line 21. The power supply unit 30 provides a power energy (Vs) to the capacitor module 22 via the power input end 211, the capacitor module 22 can be charged by the power energy (Vs). The power output end 231 of the external power supply module 20 is connected to the second connection interface 501 of the data storage device 50 via a second connection line 23.

During the data storage system 200 of the present invention is operating, when the power supply unit 30 provides the power energy (Vs), the external power supply module 20 can output the power energy (Vs) to the data storage device 50. When the power supply unit 30 interrupts to provide the power energy (Vs), the external power supply module 20 can output a standby power, for example, the standby power is a discharge energy (Vc) provided by the capacitor module 22, to the data storage device 50. Thus, the external power supply module 20 can provide the work power required by the data storage device 50 performing the writing of important data by the use of the standby power of the capacitor module 22 when the power outage of the power supply unit 30 occurs.

In an embodiment of the present invention, the first connection interface 301 of the power supply unit 30 and the second connection interface 501 of the data storage device 50 are a USB (Universal Serial Bus), respectively. The user can pull out the first connection line 21 and the second connection line 23 of the original external power supply module 20 from the first connection interface 301 of the power supply unit 30 and the second connection interface 501 of the data storage device 50 when the capacitor module 22 of the original external power supply module 20 has aged or damaged. Then, the user can insert the first connection line 21 and the second connection line 23 of the new external power supply module 20 into the first connection interface 301 of the power supply unit 30 and the second connection interface 501 of the data storage device 50, such that the replacement of the capacitor module 22 can be finished. Accordingly, the capacitor module 22 is configured in the outside of the data storage device 50, which can increase the convenience in the replacement of the capacitor module 22 by the user himself.

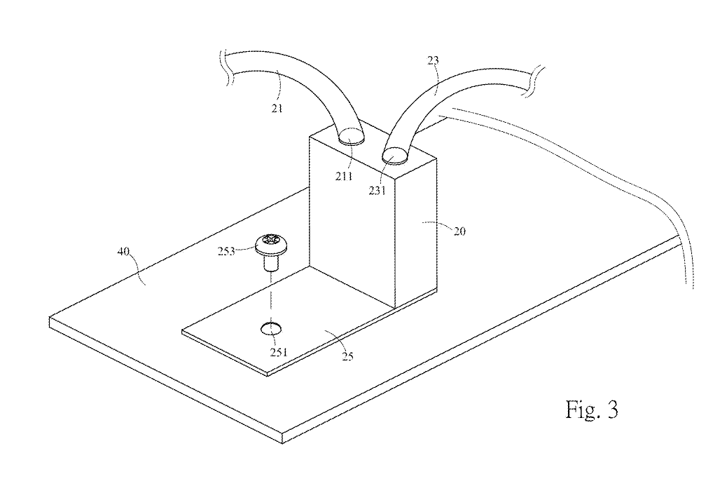

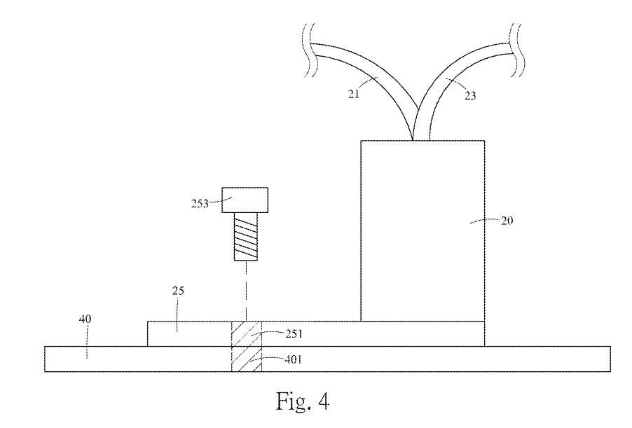

Referring to FIGS. 3 and 4, there are shown a structural stereogram diagram and a structural cross-sectional diagram of the external power supply module according to one embodiment of the present invention. As shown in FIGS. 3 and 4, a housing of the external power supply module 20 of the present embodiment can be fixed on a board body 25 that is a metal plate or a plastic plate. The external power supply module 20 can be configured on an object 40 by the board body 25. The object 40 is a motherboard, a housing of a computer host, or an object capable of fixing the external power supply module 20. The board body 25 and the object 40 comprise at least one hole 251, 401, respectively. A fixed element 253 is through the holes 251, 401 of the board body 25 and the object 40 so as to fix the board body 25 on the object 40. Therefore, the external power supply module 20 can be fixed to the object 40 via the board body 25.

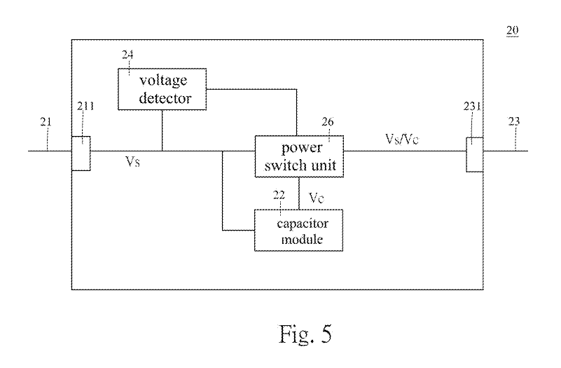

Referring to FIG. 5, there is shown a circuit diagram of the external power supply module according to one embodiment of the present invention. As shown in FIG. 5, the external power supply module 20 of the present embodiment comprises the capacitor module 22, a voltage detector 24, and a power switch 26. The voltage detector 24 is connected to the power input end 211 and used to detect a voltage value of the power energy (Vs). The power switch 26 is connected to the voltage detector 24. When the voltage value of power energy (Vs) detected by the voltage detector 24 is higher than a threshold value, the power switch unit 26 will be connected to the power input end 211 by the controlling of the voltage detector 24, the external power supply module 20 will provide power energy (Vs) to the data storage device 50. When the voltage value of the power energy (Vs) detected by the voltage detector 24 is lower than the threshold value, the power switch unit 26 will be connected to the capacitor module 22 by the controlling of the voltage detector 24, the external power supply module 20 will output the standby power (Vc) provided by the capacitor module 22 to the data storage device 50. Besides, the capacitor module 22 further comprises a boost converter, the capacitor module 22 receives the power energy (Vs) via the boost converter, in such a way that the charging speed of the capacitor module 22 can accelerate by the boost voltage of the boost converter.

Summed up the above description, the capacitor module 22 is configured in the external power supply module 20 that is located on the outside of the data storage device 50. When the capacitor module 22 of the external power supply module 20 has aged or damaged, the user can reconfigure a new external power supply module 20 between the power supply unit 30 and the data storage device 50 so as to finish the replacement process of the capacitor module 22. Of course, the user may also replace an external power supply module 20 having an appropriate capacity in the data storage system 200 according to the requirement of data access in the actual. Moreover, the volume of the data storage device 50 can designed to be a smaller size because the factor that the capacitor module 22 is configured in the external power supply module 20.

The above disclosure is only the preferred embodiment of the present invention, and not used for limiting the scope of the present invention. All equivalent variations and modifications on the basis of shapes, structures, features and spirits described in the claims of the present invention should be included in the claims of the present invention.

1. An external power supply module capable of providing a standby power, comprising:
at least one capacitor module;
a power input end connected to the capacitor module and a power supply unit, wherein the power supply unit provides a power energy to the capacitor module via the power input end, the capacitor module can be charged by the power energy; and
a power output end connected to the capacitor module and a data storage device, respectively;
wherein the external power supply module outputs the power energy to the data storage device when the power supply unit provides the power energy; the external power supply module outputs the standby power provided by the capacitor module to the data storage device when the power supply unit interrupts to provide the power energy.

2. The external power supply module to claim 1, further comprising a voltage detector that is connected to the power input end and used to detect a voltage value of the power energy, wherein the external power supply module outputs the power energy to the data storage device when the voltage value of power energy is higher than a threshold value, or the external power supply module outputs the standby power to the data storage device when the voltage value of power energy is lower than the threshold value.

3. The external power supply module to claim 2, further comprising a power switch unit connected to the voltage detector, wherein the power switch unit is connected to the power input end by the controlling of the voltage detector when the voltage value of power energy is higher than the threshold value, or the power switch unit is connected to the capacitor module by the controlling of the voltage detector when the voltage value of power energy is lower than the threshold value.

4. The external power supply module to claim 1, further comprising a first connection line and a second connection line, wherein the power input end is connected to the power supply unit via the first connection line, and the power output end is connected to the data storage device via the second connection line.

5. The external power supply module to claim 4, wherein the power supply unit comprises a first connection interface, the data storage device comprises a second connection interface, the first connection line is connected to the first connection interface of the power supply unit, the second connection line is connected to the second connection interface of the data storage device.

6. The external power supply module to claim 1, wherein a housing of the external power supply module is disposed on a board body, the external power supply module is able to be fixed on an object by the board body.

7. The external power supply module to claim 6, wherein the board body and the object comprise at least one hole, respectively, a fixed element is through the holes of the board body and the object so as to fix the board body on the object.

8. A data storage system capable of providing a standby power, comprising:
a data storage device; and
an external power supply module comprising at least one capacitor module, a power input end, and a power output end, the power input end connected to the capacitor module and a power supply unit, respectively, the power output end connected to the capacitor module and the data storage device, respectively, wherein the power supply unit provides a power energy to the capacitor module via the power input end, the capacitor module can be charged by the power energy;
wherein the external power supply module outputs the power energy to the data storage device when the power supply unit provides the power energy; the external power supply module outputs the standby power provided by the capacitor module to the data storage device when the power supply unit interrupts to provide the power energy.

9. The data storage system to claim 8, wherein the external power supply module further comprises a voltage detector that is connected to the power input end and used to detect a voltage value of the power energy, the external power supply module outputs the power energy to the data storage device when the voltage value of power energy is higher than a threshold value, or the external power supply module outputs the standby power to the data storage device when the voltage value of power energy is lower than the threshold value.

10. The data storage system to claim 9, wherein the external power supply module further comprises a power switch unit connected to the voltage detector, wherein the power switch unit is connected to the power input end by the controlling of the voltage detector when the voltage value of power energy is higher than the threshold value, or the power switch unit is connected to the capacitor module by the controlling of the voltage detector when the voltage value of power energy is lower than the threshold value.
